(19) United States
(12) Patent Application Publication
(10) Pub. No.: US 2011/0243068 A1
(43) Pub. Date: Oct. 6, 2011

(54) ASSOCIATION PROCESSING METHOD OF A MOBILE DEVICE AND A SERVICE CONTENT PROVIDING SYSTEM THEREOF

(76) Inventor: YONSUK KIM, Seo-gu (KR)

(21) Appl. No.: 13/023,205

(22) Filed: Feb. 8, 2011

(30) Foreign Application Priority Data
Mar. 31, 2010 (KR) 10-2010-0029291

(51) Int. Cl. H04W 88/02

(52) U.S. Cl. 370/328

(57) ABSTRACT

An association processing method of a mobile device, the method including accessing a service point with a mobile device for the first time, wherein the service point is connected to a service content providing server, and receiving, at the mobile device, a connection context transmitted from the service point to provide service content of the service content providing server to the mobile device through the service point, wherein the connection context is transmitted to the mobile device in response to a determination that the mobile device is permitted to receive the service content of the service content providing server.

### CROSS-REFERENCE TO RELATED APPLICATION

This U.S. non-provisional patent application claims priority under 35 U.S.C. §119 to Korean Patent Application No. 10-2010-0029291, filed on Mar. 31, 2010, the disclosure of which is incorporated by reference herein in its entirety.

### BACKGROUND

1. Technical Field

The present inventive concept relates to wireless communication of a mobile device, and more particularly, to an association processing method of a mobile device, the method not including a field association procedure, and a service content providing system thereof.

2. Discussion of the Related Art

A wireless internet function may be built into mobile devices such as a mobile phone, a mobile internet device, a personal digital assistant (PDA), a smart phone, a tablet PC, a portable telecommunication device, a portable multimedia player, or an MP3 player. These mobile devices may perform a wireless internet communication with a service content providing system through a service point, referred to as a wireless internet access point, without using a mobile communication network.

A short-range wireless communication network such as a wireless personal area network (WPAN) may be used for communication between a Kiosk serving as a service point and a mobile device.

If, for example, a mobile device's user initially accesses an arbitrary service point among a plurality of service points and attempts to use a wanted service, a field association procedure for exchanging a connection context between the mobile device and the service point is performed. However, to establish the WPAN connection, the user needs to input a preset password when first using the mobile device at this service point. However, requiring the mobile device's user to input a preset password each time they connect to a service point to receive service content can be an inconvenience.

Moreover, if, for example, a mobile device does not include an input device such as a keypad or a touchpad and a display device, the mobile device's user needs to carry a universal serial bus (USB) cable or install an input device and a display device in the mobile device to process a field association procedure. This, however, is a burdensome way of obtaining service content.

Accordingly, there is a need to improve a field association procedure of a mobile device.

### SUMMARY

The present inventive concept provides an association processing method of a mobile device, the method not including a field association procedure, and a service content providing system thereof.

In this method, the user of a mobile device can first access a service point and obtain service content from a host server via the service point without performing a field association procedure.

This may be accomplished by performing a pre-association procedure between the mobile device and a service content providing server before the mobile device is connected with a service point to obtain service content.

The present association processing method does not require the user of a mobile device to input a preset password when they first access a service point to receive service content.

In this way, the user does not have to carry an additional cable or device to receive service content.

The present association processing method further speeds and securitizes the interconnection between a wireless universal serial bus (WUSB) device and a WUSB host.

An exemplary embodiment of the inventive concept provides an association processing method of a mobile device, the method including: accessing a service point with a mobile device for the first time, wherein the service point is connected to a service content providing server; and receiving, at the mobile device, a connection context transmitted from the service point to provide service content of the service content providing server to the mobile device through the service point, wherein the connection context is transmitted to the mobile device in response to a determination that the mobile device is permitted to receive the service content of the service content providing server.

In an exemplary embodiment, the mobile device may access the service point via a short-range wireless communication link.

In an exemplary embodiment, before accessing the service point, the method comprises: transmitting, from the mobile device to the service content providing server, a serial number of the mobile device; and performing, at the service content providing server in response to receipt of the serial number, a pre-association procedure for the mobile device.

In an exemplary embodiment, the serial number may include a product serial number of the mobile device.

In an exemplary embodiment, the serial number may include a personal identification number (PIN) of a user of the mobile device.

In an exemplary embodiment, the serial number may include a manufacturing company number of the mobile device.

In an exemplary embodiment, the serial number may include an internet personal identification number (I-PIN) of a user of the mobile device.

In an exemplary embodiment, the serial number may include a government personal identification number (G-PIN) of a user of the mobile device.

In an exemplary embodiment, the pre-association procedure may include generating and registering the connection context corresponding to the serial number.

In an exemplary embodiment, the mobile device is determined to be permitted to receive the service content of the service content providing server due to the serial number and the serial number's corresponding connection context being registered in the service content providing server.

In an exemplary embodiment, the connection context comprises a connection device identification (ID), a connection host ID and a connection key.

In an exemplary embodiment of the inventive concept, a service content providing system includes: service points connected via a communication network; and a host server, wherein when a serial number of a mobile device is received when the mobile device is connected to the host server via the communication network, the host server performs a pre-association procedure for the mobile device in which the serial number of the mobile device is registered to allow the mobile device to receive service content from the host server and, when the mobile device initially accesses one of the service points to receive wanted service content, if the mobile device is registered, the host server transmits a connection context to the mobile device to cause the service point to provide the mobile device with the wanted service content.

In an exemplary embodiment, the mobile device and the service point accessed by the mobile device communicate through a wireless personal area network (WPAN).

In an exemplary embodiment, the serial number of the mobile device is provided from an input terminal connected to the communication network, wherein the mobile device is connected to the input terminal.

In an exemplary embodiment, the input terminal may be wirelessly connected to the communication network.

In an exemplary embodiment, at least one of the service points comprises a Kiosk serving as a wireless internet access point.

In an exemplary embodiment, the mobile device is wireless universal serial bus (WUSB) equipped device and at least one of the service points is a WUSB equipped host.

In an exemplary embodiment of the inventive concept, an association processing method includes: receiving, at a service content providing server, a serial number of a mobile device when the mobile device is on-line with the service content providing server; performing, at the service content providing server, a pre-association procedure in which the serial number of the mobile device is registered with a corresponding connection context; and providing, from the service content providing server to the mobile device, the connection context corresponding to the mobile device's serial number to give the mobile device immediate access to service content of the service content providing server the first time the mobile device sends a wireless service content request to a service point connected to the service content providing server.

In an exemplary embodiment, the service content providing server may include a web site for performing the pre-association procedure.

In an exemplary embodiment, the connection context is provided to the mobile device when the mobile device is on-line with the service content providing server.

In an exemplary embodiment of the inventive concept, an association processing method includes: receiving, at a service point, a service content request wirelessly sent from a mobile device, wherein the service content request is the mobile device's first contact with the service point; and sending, from the service point to the mobile device, connection information to immediately and wirelessly provide the requested service content to the mobile device through the service point, wherein the connection information is transmitted to the mobile device in response to a determination that the mobile device is permitted to receive the requested service content.

In an exemplary embodiment, the determination is made by confirming that a serial number of the mobile device is stored in a table at the service point, the table having been generated in a pre-association process between the mobile device and a host server in which the host server assigned the serial number to the connection information.

### BRIEF DESCRIPTION OF THE DRAWINGS

The above and other features of the inventive concept will become more apparent by describing in detail exemplary embodiments thereof with reference to the accompanying drawings.

FIG. 1 is a block diagram of a service content providing system according to an exemplary embodiment of the inventive concept;

FIG. 2 is a device block diagram of a host server and/or a service point of FIG. 1, according to an exemplary embodiment of the inventive concept;

FIGS. 3 and 4 each include a flowchart of an association process of a mobile device of FIG. 1, according to an exemplary embodiment of the inventive concept;

FIG. 5 is view of a memory table for an association process of a mobile device of FIG. 1, according to an exemplary embodiment of the inventive concept;

FIG. 6 is a block diagram of a service content providing system according to an exemplary embodiment of the inventive concept; and

FIG. 7 is a view illustrating a serial number transmission format of a mobile device in the service content providing system of FIG. 1 or 6, according to an exemplary embodiment of the inventive concept.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein.

It will be understood that when an element or a line is referred to as being ‘connected to’ another element or line, it can be directly connected to the another element or line, or intervening elements or lines may be present.

Like reference numerals may refer to like elements throughout the specification and drawings. In some drawings, only certain connection relationships between elements and lines are illustrated for convenience of description, and other elements or circuit blocks not shown in the drawings may be included in exemplary embodiments of the inventive concept.

Additionally, in the drawings, a service flow of a service content providing system, a general circuit configuration of a mobile device, and an association operation according thereto may be omitted.

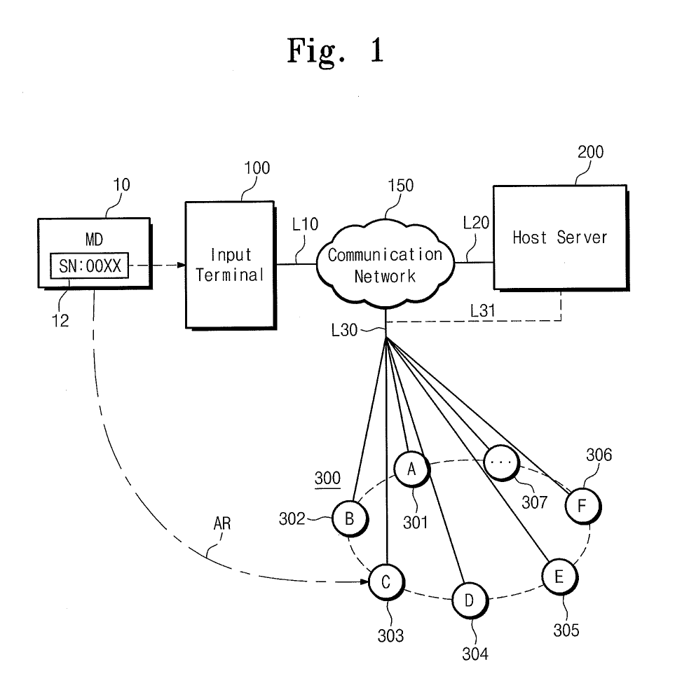

FIG. 1 is a block diagram of a service content providing system according to an exemplary embodiment of the inventive concept.

Referring to FIG. 1, the service content providing system includes service points 300 (including 301 to 307) connected via a communication network 150 and a host server 200.

A mobile device 10 receives service content of the host server 200 via at least one service point (e.g., 303) among the service points 300. The service points 300 may be wireless internet access devices (e.g., a Kiosk) installed at a public place such as a public institution, a stop, a shopping mall, and a shop and may serve as a universal serial bus (USB) host terminal device.

Once a serial number 12 of the mobile device 10 is inputted through an input terminal 100 connected to the communication network 150, it is provided to the host server 200 via a line L10, the communication network 150, and a line L20 sequentially. In this case, the serial number 12 may be provided in a pre-association request message.

The host server 200 processes a pre-association procedure for the mobile device 10 if the serial number 12 is received when the mobile device 10 is on-line with the host server 200. Next, when the mobile device 10 initially accesses one service point (e.g., 303) among the service points 300, the host server 200 confirms whether the mobile device 10 is registered based on the pre-association procedure and, if the registration is confirmed, transmits a connection context to the mobile device 10 to immediately provide the service content.

Wireless communication via a wireless personal area network (WPAN) may occur between the service point 303 and the mobile device 10. The wireless communication may also occur via a wireless local area network (LAN), and utilize technologies such as Bluetooth, Zigbee, WiGig, W-HDMI, WiHD or ultra wide band (UWB).

The connection context may include a connection device ID (CDID), a connection host ID (CHID), and a connection key (CK) as a unique ID of the wireless USB specification standard 1.0. The connection context may be transmitted to the mobile device 10 through a framework.

The CDID is generated when the mobile device 10 tries to make a new access to a service point 300. Once a temporary CDID is generated, until when a new CDID is received from a service point 300 or a current access attempt fails, the current CDID is maintained as is. Since a temporary CDID is a random number, a service point 300, e.g., a wireless USB host device, rarely gives access to the mobile device 10 using the same CDID.

The CHID is provided as a unique host ID from the service point 300. The CHID is applied to the mobile device 10 when an accept message that is a reply to an association request message is transmitted and the mobile device 10 identifies a service point 300 accessed using the CHID.

The CK as a key used for a service access is obtained after being computed by the service point 303 or the host server 200. Similarly, the CK is always a unique value.

The host server 200 or the service point 303 may exchange a connection context with the mobile device 10 through out-of-band (OOB) channels or secured USB commands. As a result, the mobile device 10 may be connected to a corresponding host server or service point by checking the CHID among the connection context.

In an exemplary embodiment of the inventive concept, the input terminal 100 may be a desktop computer or a notebook computer connected to a communication network via a wireless or wired network.

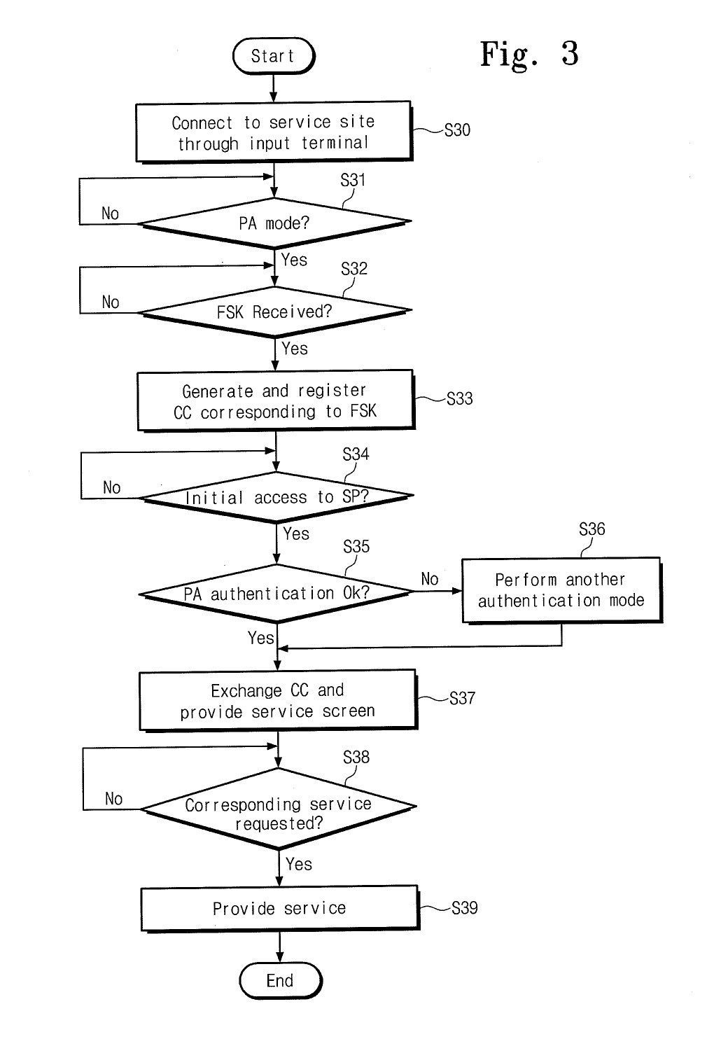

When the mobile device 10 is not connected to the input terminal 100 after a pre-association procedure, if the mobile device 10 accesses a service point 300, the connection context may be provided from the host server 200 to the mobile device 10 through the service point 300. FIG. 3 is a control flow illustrating a pre-association procedure and service provision, the service provision occurring when the mobile device 10 is not connected to the input terminal 100, according to an exemplary embodiment of the inventive concept. An association processing method of the mobile device 10 according to FIG. 3 includes performing a pre-association procedure for the mobile device 10 when a serial number of the mobile device 10 is transmitted to a service content providing server when the mobile device 10 is on-line with the service content providing server through the input terminal 100. Additionally, when the mobile device 10 initially accesses a service point 300 connected to the service content providing server when the mobile device 10 is not connected to the input terminal 100, if the pre-association procedure is confirmed such that the mobile device 10 is registered with the service content providing server, the association processing method includes transmitting a connection context to the mobile device 10 to immediately provide service content through the service point 300.

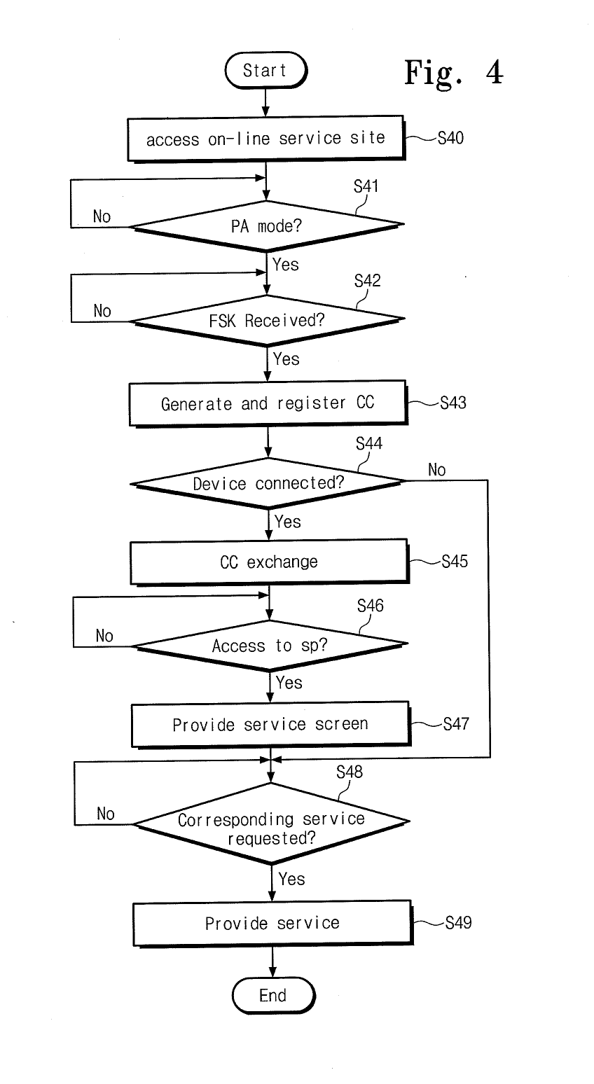

Moreover, when the mobile device 10 is connected to the input terminal 100, a connection context may be directly provided from the host server 200 to the mobile device 10. FIG. 4 is a control flow illustrating a pre-association procedure and service provision when the mobile device 10 is connected to the input terminal 100, according to an exemplary embodiment of the inventive concept. An association processing method of the mobile device 10 according to FIG. 4 includes performing a pre-association procedure for the mobile device 10 when a serial number of the mobile device 10 is transmitted to a service content providing server when the mobile device 10 is on-line with the service content providing server through the input terminal 100 and transmitting a connection context to the mobile device 10 from the service content providing server when the mobile device 10 is on-line to immediately provide service content using at least one service point 300 connected to the service content providing server when the mobile device 10 is connected to the input terminal 100 to communicate with the service contents providing server.

A dotted line L31 connected to the host server 200 of FIG. 1 represents that the host server 200 may be connected to the service points 300 without passing through the communication network 150.

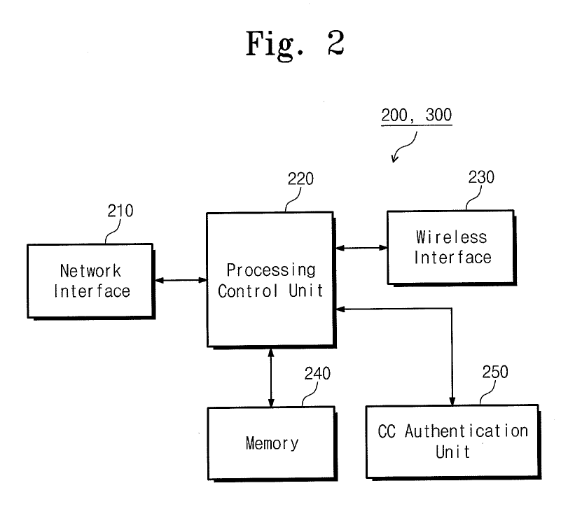

FIG. 2 is a device block diagram of the host server 200 and/or the service point 300 of FIG. 1, according to an exemplary embodiment of the inventive concept.

Referring to FIG. 2, device blocks include a network interface 210, a processing control unit 220, a wireless interface 230, a memory 240, and a connection context (CC) authentication unit 250.

If the device blocks constitute the host server 200, the network interface 210 is connected to the communication network 150 through the line L20 and is responsible for a network interface.

The processing control unit 220 provides service content and performs a pre-association procedure according to an exemplary embodiment of the inventive concept.

The wireless interface 230 may be omitted from the host server 200 if the wireless interface 230 constitutes a part of the device blocks of a service point 300 and may be responsible for an interface related to a wireless communication with the mobile device 10.

The memory 240 stores programs and various processing data of the processing control unit 220 and may include a nonvolatile memory retaining its stored data even if no power is applied and a volatile memory losing its stored data when power is cut off.

To confirm whether the mobile device 10 is pre-registered or not, the CC authentication unit 250 checks whether the CDID of the mobile device 10 is stored in a memory table in response to a connection request message of the mobile device 10. If the CDID is stored in the memory table, the CC authentication unit 250 transmits an authentication message and then, the mobile device 10 receives a connection request accepted message according thereto.

Referring to FIG. 3, a control flow of a pre-association procedure and service provision according to an exemplary embodiment of the inventive concept will be described below.

FIG. 3 is a flowchart of when the mobile device 10 is not connected to the input terminal 100 when the mobile device 10 attempts to obtain service content from a service point 300.

In operation S30, a user of the mobile device 10 accesses a service site provided by the host server 200 when on-line with the host server 200 using the input terminal 100 of FIG. 1. Here, the service site may be a web site and guide display information of the web site may be provided from the host server (e.g., a service content providing server) via the communication network 150. Here, if a user wants to have pre-association, guide information for entering into a pre-association (PA) mode may be provided. If the user enters into the PA mode through an input unit of the input terminal 100, operation S31 is skipped. In the PA mode, the host server 200 may provide a window requesting an input of a serial number related to the mobile device 10, to a screen of the input terminal 100. Here, the serial number as a fixed symmetric key (FSK) may include a product serial number of the mobile device 10, a personal identification number (PIN) of a user of the mobile device 10, a manufacturing company number of the mobile device 10, an internet personal identification number (I-PIN) of a user of the mobile device 10, or a government personal identification number (G-PIN) of a user of the mobile device 10.

In operation S32, a user inputs a serial number through an input unit of the input terminal 100. Once the serial number is inputted in operation S32, the host server 200 generates a CC in correspondence to the FSK and registers the CC in a memory table in operation S33. Operations S30 to S33 are performed on-line through a communication network such as the internet and correspond to a pre-association procedure.

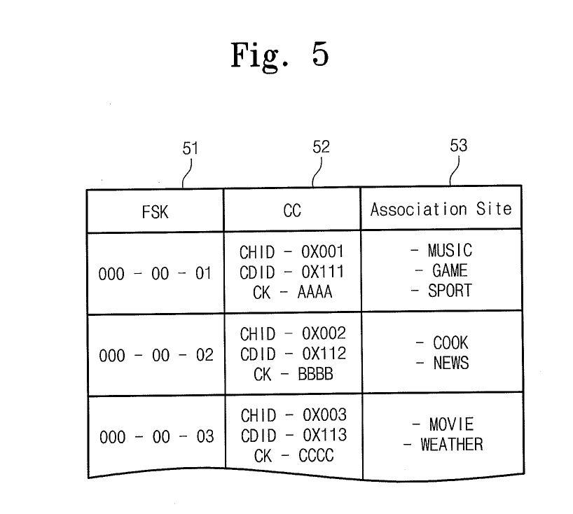

The memory table as shown in FIG. 5 is created by the completion of the pre-association procedure of FIG. 3. FIG. 5 is a drawing of a memory table, according to an exemplary embodiment of the inventive concept, in which FSK values are stored in a storage region 51 and CC values are stored in a storage region 52. An association site may be stored in a storage region 53. For example, if the mobile device 10 has a serial number of 000-00-01 and its user is registered for service content such as music, games, and sports of a specific site, a CDID of the CC values is allocated as ‘0X111” by the host server 200 and this is stored in the memory table. In this case, the CHID may be allocated as a value corresponding to an ID of the host server 200, for example, “0X001”. A CK of the CC values may be stored paired with the CDID. In this case, the CK is allocated as “AAAA”. When the pre-association procedure is performed, the storing of a value of the CHID may be omitted.

Additionally, a value of the CK is a key value used for data encryption when the host server 200 or a wireless universal serial bus (USB) host device of the service point 300 transmits or receives data to or from the mobile device 10. As a result, a value of the CK used for security of data communication is generated initially by the service point 300.

As shown in FIG. 5, when at least a CDID among CCs is allocated in correspondence to the FSK value and a table including user associated sites is generated, the pre-association procedure is completed for the moment.

When the mobile device 10, which is no longer connected to the input terminal 100, moves along an arrow symbol AR of FIG. 1 and initially accesses an arbitrary service point 303 in operation S34, it receives a message such as a predetermined micro-scheduled management command (MMC) broadcasted from the service point 303 within a several to tens of meters radius. The MMC message is a message that is transmitted periodically and is placed at a front part of a super frame to manage a mobile device and wireless channel and includes channel allocation information and host related information for each mobile device. Here, the host related information includes a CHID to distinguish each service point 300.

Here, operations S34 to S39 may be indirectly performed by the host server 200 with the support of the service point 303 or may be directly performed by the service point 303 that downloads data of the memory table of FIG. 5 from the host server 200.

In the case of the indirect operation, when the mobile device 10 transmits a predetermined connection request message to receive service content, the service point 303 receives the connection request message, and then the received message is provided to the host server 200 via the line L30, the communication network 150, and the line L20 sequentially. Here, the connection request message may include the FSK.

Accordingly, the host server 200 performs a PA authentication in operation S35. The PA authentication is accomplished by checking whether a CDID corresponding to the received FSK is stored in the memory table or not. Accordingly, since the CDID corresponding to the FSK of 000-00-01 is stored as “0X111”, the host server 200 provides an authentication message to the service point 303.

If the PA authentication is successful in operation S35, it proceeds to operation S37. In operation S37, the CC exchange is accomplished, and a service initial screen is displayed on the mobile device 10, if necessary. The CC exchange operation includes providing the CDID, CHID, and CK to the mobile device 10 and storing the CC in the host server 200 or the service point 303. Here, the CC exchange operation may be performed using a specific security enhanced code to provide improved safety.

Moreover, if the PA authentication fails in operation S35, another authentication mode may be performed in operation S36. The another authentication mode may include a typical association mode in which a user directly inputs a specific password.

Since a user of the mobile device 10 finished a pre-association procedure in its prior on-line communication with the host server 200, when the mobile device 10 is connected initially to the service point 303, as long as the PA authentication is successful, a service initial screen may be automatically displayed without having to perform an additional input operation for an association procedure.

Accordingly, if the user wants to download music, the flow skips to the operation S38 and then, the user receives wanted service content in operation S39. In this manner, the mobile device 10 in a field is automatically in a state where it can receive service content due to its initial a pre-association with the host server 200, such that the mobile device 10 is more convenient to use.

Referring to FIG. 4, a control flow of when the mobile device 10 is connected to the input terminal 100 for pre-association and to receive service content will be illustrated.

Since operations S40, S41, S42, and S43 of FIG. 4 correspond to operations S30, S31, S32, and S33 of FIG. 3, their detailed descriptions will be omitted.

Operation S44 is skipped if the mobile device 10 is connected to the input terminal 100 through a wired or wireless network. As a result, if the mobile device 10 is connected to the input terminal 100, a CC exchange is accomplished in operation S45. The CC exchange operation includes providing the CDID, CHID, and CK to the mobile device 10 and storing the CC in the host server 200 or the service point 303. In this case, the pre-association procedure of steps S40-S43 has already been completed and the CC exchange of step S45 is accomplished since the mobile device 10 is on-line with the host server 200. In the same manner, the CC exchange operation may be performed using a specific security enhanced code to provide improved safety.

When the mobile device 10 moves along the arrow symbol AR of FIG. 1 and initially accesses an arbitrary service point 303 in operation S46, since the CC exchange is already accomplished in operation S45, the mobile device 10 is in a state to receive service content in operation S45. When the mobile device 10 accesses the service point 303, only an ID (CHID) of the connection host is changed and the CDID and CK values are maintained as they are.

As a result, when a user initially accesses the service point 303, a service initial screen may be automatically displayed without the need for a user to perform an additional input operation for an association procedure.

Therefore, operation S48 is skipped if a wanted service is requested and a user receives requested service content in operation S49. Accordingly, since service content is provided without the input of a password by a user, the mobile device is more convenient to use. Additionally, the user's convenience is enhanced since they do not have to carry a cable or install an input device and a display device in the mobile device to effectuate a field association procedure.

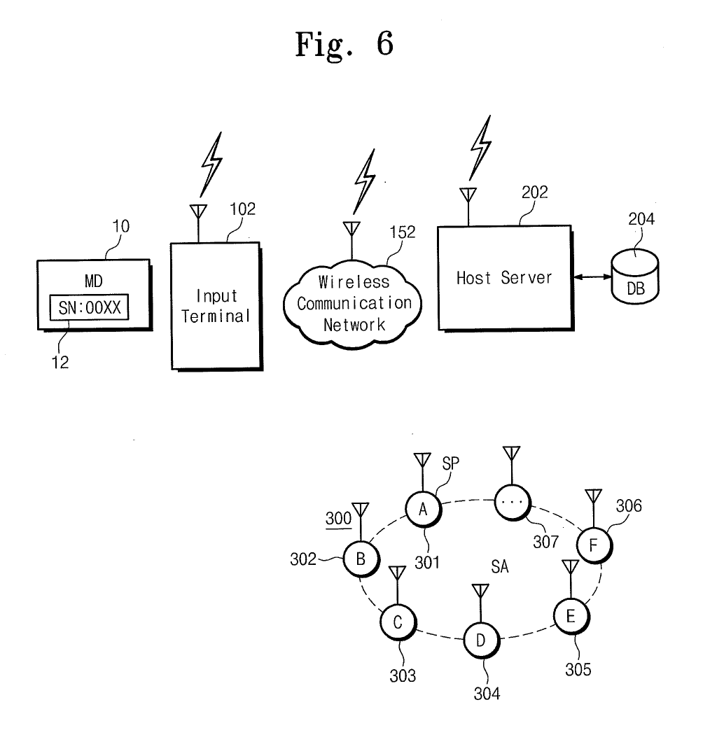

FIG. 6 is a block diagram of a service content providing system according to an exemplary embodiment of the inventive concept.

Referring to FIG. 6, the service content providing system includes service points 300 connected via a wireless communication network 152 and a host server 202.

The mobile device 10 receives service content from the host server 202 via at least one service point (e.g., 303) among the service points 300 (including 301 to 307). The service points 300 may be a wireless internet access device (e.g., a Kiosk) installed at a public place such as a public institution, a stop, a shopping mall, and a shop and may serve as a USB host terminal device.

Once a serial number 12 of the mobile device 10 is inputted through a wireless input terminal 102 connected to the communication network 152, it is provided to the host server 202 wirelessly. In this case, the serial number 12 may be included in a pre-association request message.

The host server 202 performs a pre-association procedure for the mobile device 10 if the serial number is received when the mobile device 10 is on-line with the host server 202. Next, when the mobile device initially accesses one service point (e.g., 303) among the service points 300, if the pre-association procedure was completed and it is confirmed that the mobile device 10 is registered, the host server 202 transmits a connection context to the mobile device 10 to immediately provide service content.

Similarly to that described for FIG. 1, a WPAN may be established between the service point 303 and the mobile device 10.

The host server 202 may include an additional database 204 to store data of the table of FIG. 5.

In the case of FIG. 6, the above mentioned pre-association procedure and service provision may be accomplished when the mobile device 10 is on-line.

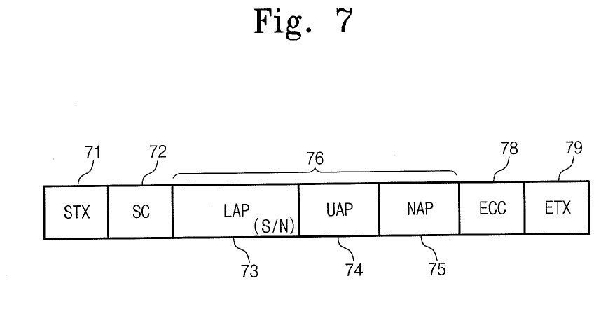

FIG. 7 is a view illustrating a serial number transmission format of the mobile device 10 in the service content providing system of FIG. 1 or 6, according to an exemplary embodiment of the inventive concept. For example, the transmission frame may include STX 71, SC 72, LAP 73, UAP 74, NAP 75, ECC 78, and ETX 79. A data bit notifying the start of the transmission is allocated to the STX 71, and a data bit notifying synchronization of the transmission frame is applied to the SC 72. The serial number such as FSK may be allocated to a body region 76 including the LAP 73, the UAP 74, and the NAP 75. A product serial number of the mobile device 10 may be allocated as a hexacode to the LAP 73, and a manufacturing company number of the mobile device 10 may be allocated as a hexacode to the UAP 74 and the NAP 75. The ECC is a code for error correction and the ETX is a code notifying the end of the transmission.

The LAP is the acronym of a Lower Address Part, the UAP is the acronym of an Upper Address Part and the NAP is the acronym of a Non-significant Address Part.

In the same manner as discussed above, when a user of the mobile device 10 applies a serial number through the input terminal 100 or 102, information of the data format of FIG. 7 may be provided to the host server 200 or 202.

As mentioned above, according to an exemplary embodiment of the inventive concept because pre-association is performed when a mobile device is on-line with a host server, a field association procedure is not additionally required at a service point first accessed by the mobile device. Additionally, because the mobile device communicates wirelessly with the service point no additional cable for receiving service content or additional device for input or display is required. Therefore, making the mobile device convenient to use.

Exemplary embodiments of the inventive concept may be realized with various methods, devices, or systems. Moreover, if exemplary embodiments of the inventive concept are realized using computer software, components of the embodiments may be replaced with or processes of the embodiments may be embodied as a program or a code segment for performing necessary operations. The program or code segment may be stored in a recording medium accessible using a microprocessor, and may be transmitted through a data format combined with a carrier waves via a transmission medium or a communication network.

The recording medium may include a medium transmitting or storing data such as an electronic circuit, a semiconductor memory device, a read only memory (ROM), a flash memory, an electrically erasable programmable read only memory (EEPROM), a floppy disk, an optical disk, a hard disk, an optical fiber, and a wireless network.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. An association processing method of a mobile device, the method comprising:
accessing a service point with a mobile device for the first time, wherein the service point is connected to a service content providing server; and
receiving, at the mobile device, a connection context transmitted from the service point to provide service content of the service content providing server to the mobile device through the service point,
wherein the connection context is transmitted to the mobile device in response to a determination that the mobile device is permitted to receive the service content of the service content providing server.

2. The method of claim 1, wherein the mobile device accesses the service point via a short-range wireless communication link.

3. The method of claim 1, wherein before accessing the service point, the method comprises:
transmitting, from the mobile device to the service content providing server, a serial number of the mobile device; and
performing, at the service content providing server in response to receipt of the serial number, a pre-association procedure for the mobile device.

4. The method of claim 2, wherein the serial number comprises a product serial number of the mobile device.

5. The method of claim 2, wherein the serial number comprises a personal identification number (PIN) of a user of the mobile device.

6. The method of claim 2, wherein the serial number comprises a manufacturing company number of the mobile device.

7. The method of claim 2, wherein the serial number comprises an internet personal identification number (I-PIN) of a user of the mobile device.

8. The method of claim 2, wherein the serial number comprises a government personal identification number (G-PIN) of a user of the mobile device.

9. The method of claim 2, wherein the pre-association procedure comprises generating and registering the connection context corresponding to the serial number.

10. The method of claim 9, wherein the mobile device is determined to be permitted to receive the service content of the service content providing server due to the serial number and the serial number's corresponding connection context being registered in the service content providing server.

11. The method of claim 1, wherein the connection context comprises a connection device identification (ID), a connection host ID and a connection key.

12. A service content providing system, comprising:
service points connected via a communication network; and
a host server, wherein when a serial number of a mobile device is received when the mobile device is connected to the host server via the communication network, the host server performs a pre-association procedure for the mobile device in which the serial number of the mobile device is registered to allow the mobile device to receive service content from the host server and, when the mobile device initially accesses one of the service points to receive wanted service content, if the mobile device's serial number is registered with the host server, the host server transmits a connection context to the mobile device to cause the service point to provide the mobile device with the wanted service content.

13. The system of claim 12, wherein the mobile device and the service point accessed by the mobile device communicate through a wireless personal area network (WPAN).

14. The system of claim 12, wherein the serial number of the mobile device is provided from an input terminal connected to the communication network, wherein the mobile device is connected to the input terminal.

15. The system of claim 14, wherein the input terminal is wirelessly connected to the communication network.

16. The system of claim 12, wherein at least one of the service points comprises a Kiosk serving as a wireless internet access point.

17. The system of claim 12, wherein the mobile device is wireless universal serial bus (WUSB) equipped device and at least one of the service points is a WUSB equipped host.

18. An association processing method, the method comprising:
receiving, at a service content providing server, a serial number of a mobile device when the mobile device is on-line with the service content providing server;
performing, at the service content providing server, a pre-association procedure in which the serial number of the mobile device is registered with a corresponding connection context; and
providing, from the service content providing server to the mobile device, the connection context corresponding to the mobile device's serial number to give the mobile device immediate access to service content of the service content providing server the first time the mobile device sends a wireless service content request to a service point connected to the service content providing server.

19. The method of claim 18, wherein the service content providing server comprises a web site for performing the pre-association procedure.

20. The method of claim 18, wherein the connection context is provided to the mobile device when the mobile device is on-line with the service content providing server.

21. An association processing method, the method comprising:
receiving, at a service point, a service content request wirelessly sent from a mobile device, wherein the service content request is the mobile device's first contact with the service point; and
sending, from the service point to the mobile device, connection information to immediately and wirelessly provide the requested service content to the mobile device through the service point,
wherein the connection information is sent to the mobile device in response to a determination that the mobile device is permitted to receive the requested service content.

22. The method of claim 21, wherein the determination is made by confirming that a serial number of the mobile device is stored in a table at the service point, the table having been generated in a pre-association process between the mobile device and a host server in which the host server assigned the serial number to the connection information.
